(19) United States
(12) Patent Application Publication
(10) Pub. No.: US 2008/0065446 A1
(43) Pub. Date: Mar. 13, 2008

(54) WEB COLLABORATION IN MULTIPLE LANGUAGES

(75) Inventors: Aliasgar A. Haveliwala, Sammamish, WA (US); Akira Hayashi, Everett, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/467,386

(22) Filed: Aug. 25, 2006

(51) Int. Cl. G06F 9/46

(52) U.S. Cl. 705/8

(57) ABSTRACT

A method and system for presenting a virtual meeting in a user's preferred language is provided. A meeting organizer sends an invitation in a particular language to join an online meeting to each potential meeting participant. When the scheduled time for the online meeting arrives, the meeting participant uses the invitation to connect to the online meeting. When each meeting participant connects to the meeting, the meeting system determines the user interface language that the participant will see once connected to the meeting and invokes the meeting client application in the determined language.

### BACKGROUND

Today's global economy demands effective worldwide communication. For example, manufacturers often have suppliers located across the country or around the world. Timely and effective communication between the manufacturer and supplier can be critical to business success. As another example, companies often assign business projects to work groups with members physically located around the world. In some situations, the work group members can belong to different organizations and/or companies. As with manufacturers and suppliers, timely and effective communication can be critical to the success of the work group.

Face-to-face meetings have been the traditional method of communicating, but with organizations becoming increasingly geographically dispersed, these meetings often require travel (e.g., from an Asian country to the United States) on the part of attendees and, thus, are becoming increasingly time and cost prohibitive. With the proliferation of computers and the advent of the Internet, and in particular, the maturing of the World Wide Web (“web”), these meetings are increasingly taking place virtually over computer networks through the use of electronic communication technologies, such as virtual meeting and application sharing software.

Virtual meeting software allows multiple users to participate in a meeting from their computers, thus avoiding the high costs associated with face-to-face meetings. To conduct a virtual meeting, a meeting host, or “organizer,” first chooses a meeting time and invites prospective attendees, or “invitees.” Invitees can respond to the invitation by indicating whether or not they will attend the meeting. At the scheduled time, the organizer and participating invitees, or “participants,” connect using the virtual meeting software, typically through a computer network. Once connected, the virtual meeting software provides a virtual environment intended to simulate a face-to-face meeting.

Virtual meeting software provides the organizer and participants with a variety of functions, or “utilities.” These utilities allow the organizer and participants to meet and discuss matters in a way similar to the way they would in an ordinary face-to-face meeting. Typical virtual meeting software may include support for utilities such as a drawing board, chat, application sharing, audio, and video. It is with these utilities that the organizer and participants are able to communicate and exchange ideas.

The organizer and participants interact with the virtual meeting software through a client user interface (“UI”). A typical UI provides the organizer and participants with text-based menus and/or buttons to access the utilities the software supports. For example, a participant wishing to initiate a chat session could do so by clicking on the appropriate button or menu item provided by the UI. This action would open a chat window through which the participant could communicate with the organizer and/or other participants.

Currently, virtual meeting software allows the organizer to select the UI language presented to all participants. Because organizers and participants may be more comfortable with different languages, some participants find it problematic to interact with the virtual meeting software in an unfamiliar or undesired language. For example, an organizer wishing to discuss matters in English may create a meeting with English as the UI language. The organizer may then invite several participants who, while conversant in English, may have limited experience reading and/or writing in English. These participants will find it difficult to access the utilities provided by the virtual meeting software if they are unable to navigate through the UI. This inability to make full use of the software hinders communication as these participants must devote more time to learning the software and less time participating in the meeting.

Another problem with current virtual meeting software is that meeting content is received and/or provided in a single language. Because participants may be more familiar with other languages, it may be difficult for the participants to fully participate in a meeting taking place in another language. For example, a meeting host may invite participants from France and Italy and decide to conduct the meeting in Japanese. The meeting host may open a chat utility through which participants can type questions to the host. With current virtual meeting software, each participant would have to ask questions in Japanese. The French and Italian participants, while conversant in Japanese, may feel more comfortable typing in French or Italian. The difficulty of communicating in an unfamiliar language may lead to participants choosing to ask fewer questions or to participate less in the meeting, reducing the effectiveness of the virtual meeting.

### SUMMARY

A method and system for presenting an online event such as a virtual meeting in a user's preferred language is provided. A meeting organizer first sends an invitation in a particular language to join an online meeting to each potential meeting participant. When the scheduled time for the online meeting arrives, the meeting participant uses the invitation to connect to the online meeting. When each meeting participant connects to the meeting, the meeting system determines the user interface language that the participant will see once connected to the meeting. Finally, the meeting system invokes the meeting client application and specifies the determined language. The client application then presents the user interface in the specified language. In this way, the user is able to interact with the meeting software in a language that is comfortable and easy to use, rather than in the language dictated by the meeting organizer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the meeting system in one embodiment.

FIG. 2 is a flow diagram that illustrates the processing of the meeting participant component of the meeting system in one embodiment.

FIG. 3 is a flow diagram that illustrates the processing of the determine language component of the meeting system in one embodiment.

FIG. 4 is a flow diagram that illustrates the processing of the meeting server component of the meeting system in one embodiment.

FIG. 5 is a flow diagram that illustrates the processing of the meeting organizer component of the meeting system in one embodiment.

FIG. 6 illustrates a user interface of the meeting client software of the meeting system in one embodiment.

### DETAILED DESCRIPTION

A method and system for presenting a virtual meeting in a user's preferred language is provided. A meeting organizer first sends an invitation in a particular language to join an online meeting to each potential meeting participant. For example, the meeting organizer may send an invitation in English to three potential meeting participants to have a meeting at 3 p.m. the following Friday. After a participant receives the invitation, the participant may accept or reject the invitation. For example, if a meeting participant cannot attend the meeting at the scheduled time, the participant may reject the invitation. When the scheduled time for the online meeting arrives, the meeting participant uses the invitation to connect to the online meeting. For example, the meeting system may include a meeting server that provides a “meeting place” for the meeting organizer to find each of the meeting participants. The meeting server may provide each participant with the organizer's Internet address, or the meeting server may act as a proxy, sending communications between the organizer and the participants. When each meeting participant connects to the meeting, the meeting system determines the user interface language that the participant will see once connected to the meeting. In some embodiments, the user interface language is determined by identifying the default language that is configured in the participant's web browser. The participant's browser is often a good place to locate the language that the user prefers since the meeting invitation may be in the form of a web link that is activated to join the meeting, such that the user's web browser will already be open and available to the meeting system to determine the user's preferred language. Finally, the meeting system invokes the meeting client application and specifies the determined language. The client application then presents the user interface in the specified language. For example, the menus, toolbar, and prompts within the application may reflect the specified language. In this way, the user is able to interact with the meeting software in a language that is comfortable and easy to use, rather than in the language dictated by the meeting organizer.

In some embodiments, the meeting system uses a script on a web page to determine the participant's preferred language. A common way of sending a meeting invitation is by sending a link containing a Uniform Resource Locator (URL) and parameters relevant to the meeting, such as a meeting identifier. When the participant activates the link to join the meeting, the participant's web browser opens and takes the user to a web page that provides a virtual entrance to the meeting. The web page may display meeting details to the participant and offer to launch client software for connecting to the meeting. Because the user is already in the web browser, and the web browser may launch the meeting client software, a script on the meeting web page can query the browser for the browser's default language and pass this information to the client application when it is invoked.

In some embodiments, the meeting system determines the participant's preferred language based on the language selected when the participant registered with the meeting system. To participate in online meetings, meeting organizers and participants may first register with a meeting server. The meeting server collects information and preferences from the users of the meeting system and stores this information for use when conducting meetings. The meeting server may request that the user specify a preferred meeting language, and when the user is a participant in a meeting, the meeting system may use this language as the language specified to the meeting client software. The meeting server may also provide downloads of the meeting client software in the language specified by the meeting participant.

In some embodiments, the meeting system determines the participant's preferred language based on the language selected when the participant installed the client application. For example, the meeting system may be integrated with the participant's email program, such as Microsoft Outlook, such that the participant receives meeting requests and joins online meetings by interacting with email within the email program. When the participant joins an online meeting, the email program may contain an add-in that acts as the meeting client application, or it may invoke a separate client application. Since the participant's browser is not involved in joining the online meeting, the meeting system may retrieve the participant's preferred language based on the language specified when the participant installed the email program.

In some embodiments, the meeting system selects an alternate language when the meeting client software does not support the participant's preferred language. For example, the participant may have a browser default language of Chinese, but the meeting client application may not be available in Chinese. Therefore, the meeting client software may select an alternate language based on other information. For example, the meeting system may contain a list of languages that are most often known by participants who request a preferred language that is not available. The meeting system may also default to the meeting organizer's requested language, since the meeting is likely to contain some content in that language anyway. The meeting system may also prompt the user to specify the preferred language.

In some embodiments, the meeting system allows the participants to exchange meeting content in languages other than the user interface language. For example, if there are three meeting participants, one may be using a client application with a Japanese user interface, another with an English user interface, and a third with a French user interface. If the meeting organizer wishes to communicate in English, each of the three participants may receive meeting content in English. For example, the meeting organizer may open a chat window visible to each of the participants in which the organizer types text in English. Similarly, each of the meeting participants may send replies to typed text in each of their preferred languages. For example, the Japanese participant may respond to a question using Japanese text. It is up to each of the meeting participants to establish which languages will be accepted during the meeting for meeting content, regardless of the language of the user interface being presented to each of the participants. In some embodiments, the meeting software may translate meeting content from the language provided by the participant who generated the content to the languages of each of the other participants. For example, one participant may type text in Japanese and another participant may receive the text translated into English.

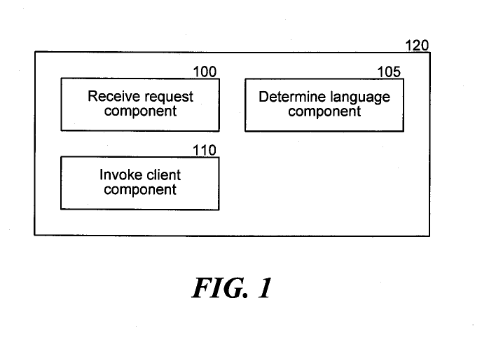

FIG. 1 is a block diagram that illustrates components of the meeting system in one embodiment. The meeting system 120 contains a receive request component 100, a determine language component 105, and an invoke client component 110. The receive request component 100 receives a meeting invitation from a meeting organizer in a language selected by the meeting organizer. The determine language component 105 determines the language that the meeting participant will use to interact with the meeting client software during the meeting. For example, the determined language may be based on a default language specified by the participant's browser. The invoke client component 110 uses information about the meeting contained in the invitation and the determined user interface language to invoke the meeting client software in the determined language. The client application connects to the online meeting and presents a user interface in the determined language. For example, the menus, toolbar, and other components of the user interface may be displayed in the determined language.

The computing device on which the system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

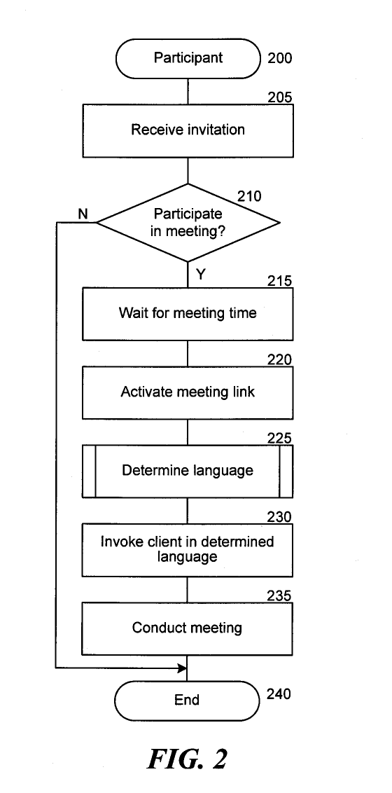

FIG. 2 is a flow diagram that illustrates the processing of the meeting participant component of the meeting system in one embodiment. In block 205, the component receives an invitation to join an online meeting. In decision block 210, if the meeting participant will participate in the meeting, then the component continues at block 215, else the component completes and optionally sends a meeting rejection to the meeting organizer. In block 215, the component waits for the scheduled meeting time contained in the meeting invitation. In block 220, the component activates the link to the meeting. In block 225, once the link is activated the component determines the language in which the user interface of the client application is presented to the participant. In block 230, the component invokes the client application in the determined language. In block 235, the component conducts the meeting and the meeting participant uses the client application in the determined language. The component then completes.

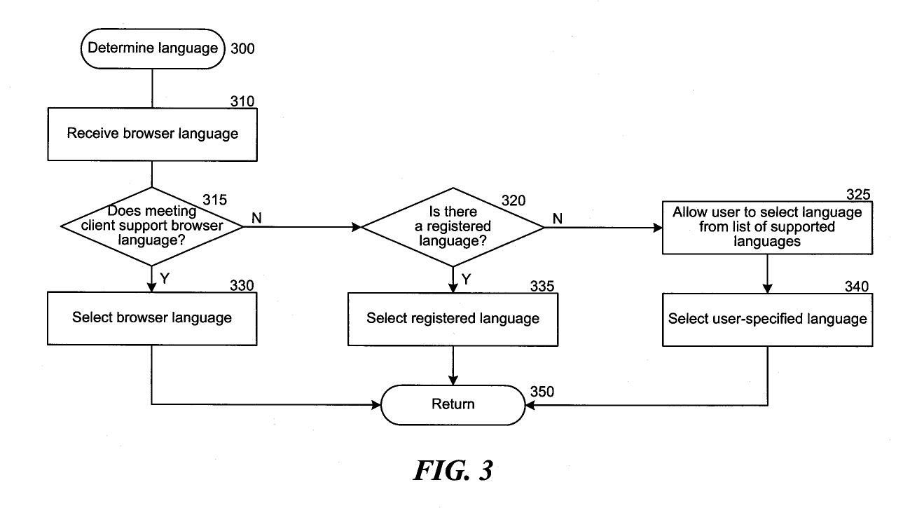

FIG. 3 is a flow diagram that illustrates the processing of the determine language component of the meeting system in one embodiment. The determine language component is invoked to determine the language in which the user interface of the meeting client application will be presented. In block 310, the component receives the default language from the participant's web browser. In decision block 315, if the meeting client application supports the language received from the web browser, then the component continues at block 330, else the component continues at block 320. In block 330, the component selects the default browser language as the language to use for the user interface of the meeting client application and completes. In decision block 320, if there is a language that was specified when the participant registered with the meeting system, then the component continues at block 335, else the component continues at block 325. In block 335, the component selects the registered language as the language to use for the user interface of the meeting client application and completes. In block 325, the component prompts the user to specify a language to use. In block 340, the component selects the specified language as the language to use for the user interface of the meeting client application and then completes.

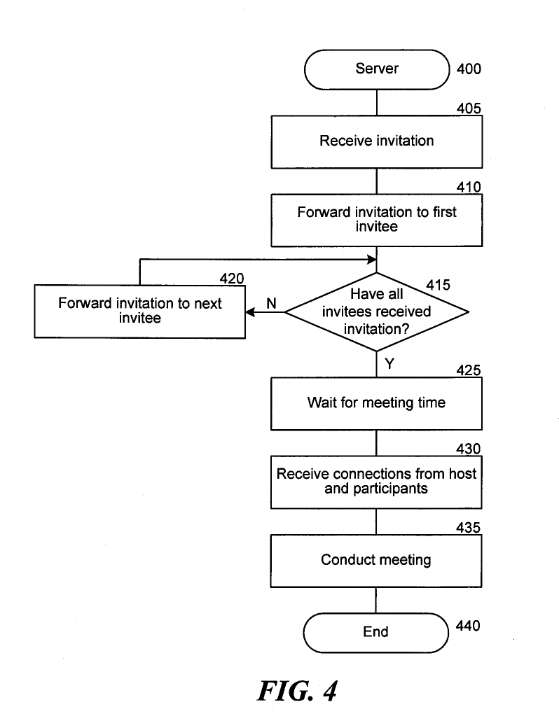

FIG. 4 is a flow diagram that illustrates the processing of the meeting server component of the meeting system in one embodiment. In block 405, the component receives an invitation from the meeting organizer. In block 410, the component forwards the invitation to the first meeting participant specified in the invitation. In decision block 415, if all participants have been sent the invitation, then the component continues at block 425, else the component continues at block 420. In block 420, the component forwards the invitation to the next meeting participant specified in the invitation and loops to block 415. In block 425, the component waits for the scheduled time of the meeting. In block 430, the component receives connection requests from the meeting organizer and each of the meeting participants to connect to the meeting. In block 435, the component facilitates communication during the meeting. The component then completes.

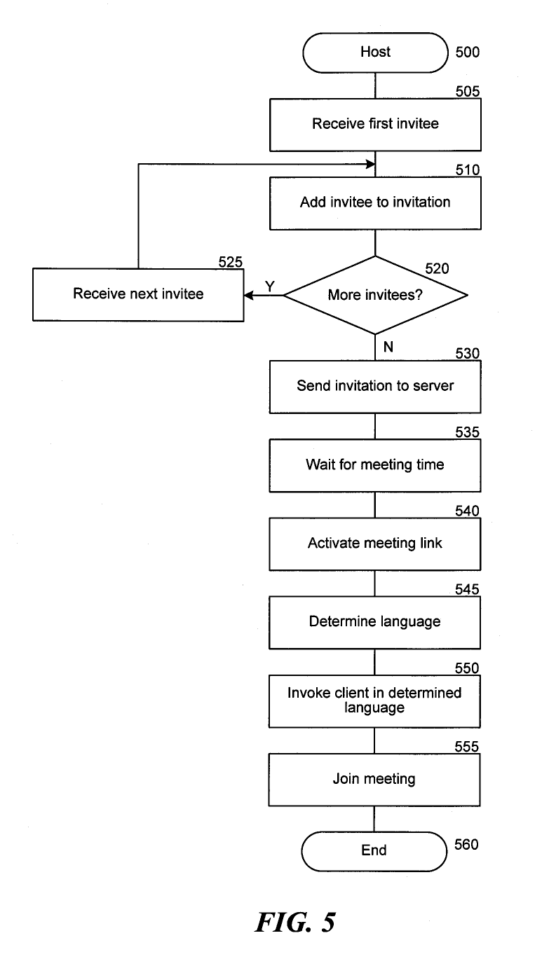

FIG. 5 is a flow diagram that illustrates the processing of the meeting organizer component of the meeting system in one embodiment. In block 505, the component receives the first meeting participant to be invited to the meeting from the meeting organizer. In block 510, the component adds the participant to the meeting invitation. In decision block 520, if there are more participants to be added to the meeting invitation, then the component continues at block 525, else the component continues at block 530. In block 525, the component receives the next meeting participant from the meeting organizer and loops to block 510 to add the participant to the meeting invitation. In block 530, the component sends the meeting invitation to the meeting server. In block 535, the component waits for the scheduled time of the meeting. In block 540, the component activates a link to the meeting. The link may be received from the server in response to sending the meeting invitation, for example, or may be generated by the meeting organizer. In block 545, the component determines the language that the meeting organizer will use for the user interface of the meeting client software. In block 550, the component invokes the meeting client software in the determined language. In block 555, the component joins the meeting organizer to the meeting. The component then completes.

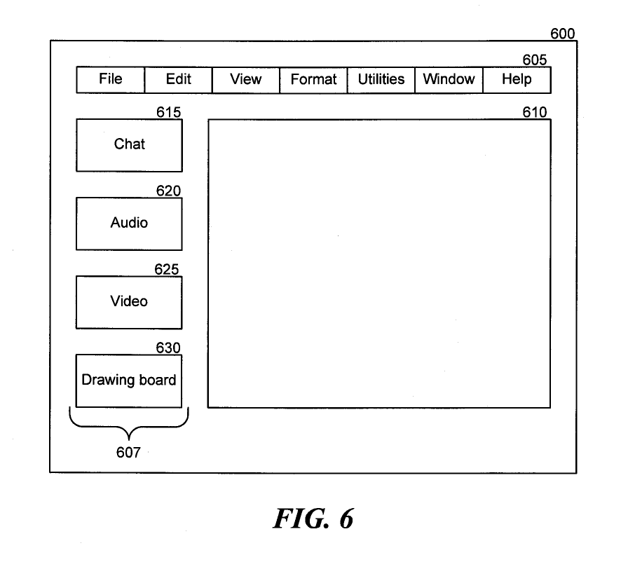

FIG. 6 illustrates a user interface of the meeting client software of the meeting system in one embodiment. The user interface 600 contains a menu 605, a toolbar 607, and a meeting content area 610. The menu 605 contains menus labeled in a selected user interface language. For example, the “File” menu is shown in English. The toolbar 607 contains a chat button 615, an audio button 620, a video button 625, and a drawing board button 630 for initiating meeting content in various formats. The meeting content area 610 displays the meeting content initiated by the meeting participant using the user interface and the content sent by other meeting participants. The meeting content area 610 may contain content in a variety of languages, such as chat text in French, even though the participant's user interface 600 is displayed in English. This allows the meeting participant to interact with the user interface 600 in a language that the participant is comfortable with, regardless of the language being used to conduct the meeting.

From the foregoing, it will be appreciated that specific embodiments of the meeting system have been described herein for purposes of illustration, but that various modifications may be made without deviating from the spirit and scope of the invention. For example, although meetings have been described, similar techniques could be used for other online events such as spectator events (e.g., horse races, football games, etc.), online auctions, and online movies. Accordingly, the invention is not limited except as by the appended claims.

I/We claim:

1. A method in a computer system for selecting a language of a user interface for participating in an online meeting, the method comprising:
receiving an invitation to join an online meeting;
determining a user interface language for participating in the online meeting; and
invoking a client component to join the online meeting wherein the user interface of the client component is presented in the determined user interface language and different participants participate in the meeting using different user interface languages.

2. The method of claim 1 wherein determining a user interface language includes receiving a preferred user interface language.

3. The method of claim 2 wherein the preferred user interface language is determined by receiving an indication from an application in the computer system.

4. The method of claim 3 wherein the application is a browser.

5. The method of claim 2 further comprising, when the preferred interface language is not supported, determining a supported user interface language.

6. The method of claim 5 wherein the selected user interface language is a language selected during registration of the client component.

7. The method of claim 1 wherein determining a user interface language comprises receiving a user interface language selection from a user when the client component is invoked.

8. The method of claim 1 wherein the client component receives content in a language other than the determined user interface language.

9. A system for selecting a language of a user interface, the system comprising:
an invitation receiving component for receiving requests to join an online meeting;
a language determining component for determining a user interface language for participating in the online meeting; and
a client component for joining the online meeting wherein the user interface of the client component is presented in the determined user interface language and different participants participate in the online meeting using different user interface languages.

10. The system of claim 9 wherein the user interface language is determined by receiving an indication from an application.

11. The system of claim 10 wherein the application is a browser.

12. The system of claim 9 wherein the language determining component determines a supported user interface language when a preferred interface language is not supported.

13. The system of claim 12 wherein the user interface language is determined based on a language selected during registration of the client component.

14. The system of claim 9 wherein the user interface language is determined by receiving a user interface language selection from a user when the client component is invoked.

15. The system of claim 9 wherein the client component receives content in a language other than the determined user interface language.

16. A computer-readable medium containing instructions for facilitating an online meeting, by a method comprising:
receiving an invitation to connect to an online meeting, the invitation having a specified language; and
forwarding the invitation to a plurality of prospective online meeting participants wherein the preferred user interface language of at least one participant is different than the invitation language,
such that after at least one participant receives the invitation, the participant joins the online meeting using a client component presenting a user interface in the participant's preferred language wherein different participants participate in the online meeting using different user interface languages.

17. The computer-readable medium of claim 16 wherein the invitation specifies a language that is not supported by the client component.

18. The computer-readable medium of claim 17 wherein the preferred user interface language is determined by receiving an indication from an application in the computer system.

19. The computer-readable medium of claim 16 wherein the client component determines the preferred user interface language based on the default language of the participant's browser.

20. The computer-readable medium of claim 16 including sending meeting content to the client component in a language other than the user interface language.
